(19) United States
(12) Patent Application Publication
(10) Pub. No.: US 2004/0137183 A1
(43) Pub. Date: Jul. 15, 2004

(54) Photographic paper for printers

(76) Inventors: Joao Alfredo Monteiro Luna, Rio de Janeiro (BR); Arides Garcia de Luna, Rio de Janeiro (BR)

Correspondence Address: Michael A. Mann, NEXSEN, PRUET, JACOBS & POLLARD, LLC, P.O. Box 2426, Columbia, SC, 29202, US

(21) Appl. No.: 10/719,186

(22) Filed: Nov. 21, 2003

Related U.S. Application Data
(63) Continuation-in-part of application No. 09/934,730, filed on Aug. 22, 2001, now abandoned.

(30) Foreign Application Priority Data
Aug. 23, 2000 (BR) 0003756-7

(51) Int. Cl. B32B 9/00

(52) U.S. Cl. 428/40.1

(57) ABSTRACT

A laminated product and a process for making the laminated product for use in printing photographs by printers consist of applying a low-tack adhesive (7) to a low-weight paper liner (8) and then applying a photographic paper (5) to the adhesive-coated liner. The laminated product is coiled and fed into cutting equipment. Then a first, half-cut is made by the cutting equipment through the photographic paper only and not also through the adhesive and liner. This half-cut (2) is made in a pre-selected size inside the area (3) that will be printed with the photographic image. A second cut (1) is made to define a photographic sheet that includes a safety margin (4) outside the photographic image area (3) and the half-cut (2). Alternatively, several photographic images can be made with corresponding half-cuts in one sheet. The photographs will have smooth edges when separated from the adhesive and the liner.

### CROSS REFERENCE TO RELATED APPLICATIONS

This application is a continuation in part application of Ser. No. 09/934,730, filed Aug. 22, 2001, incorporated herein by reference, which claims priority to Brazilian application 0003756-7, filed Aug. 23, 2000.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention refers to a process for making photographs by printers, where the final products, the photographs, in any pre-determined size, fill all pre-designated areas, without undesirable white borders and with perfectly smooth edges.

Prior art digital photographic papers for printing in inkjet printers, thermal transference, wax jet, etc. exist in flat sheets in standard sizes designated as A4 format (210×297 cm) and letter format (216×179 cm). There is also the A6 format (102×152 cm) that has borders beyond the determined size of the photograph and that can vary in size from one supplier to another. The edges of the borders are micro-serrated so that they can be removed from the photograph portions of the paper by tearing, but leave a roughened edge to the photograph.

In U.S. Pat. No. 6,344,891 issued to Imai, there is described a type of “recording material” for use with a thermal printer and that is a laminated. The laminated recording material includes a “sticker sheet,” an adhesive layer, and release paper. The sticker sheet is half-cut so that the stickers can be peeled from the release paper. The recording material is coiled for printing. Importantly, the adhesive layer is on the back of the sticker layer and thus remains with the sticker.

The patent issued to Courmoyer et al, U.S. Pat. No. 6,045,965, teaches another laminated photographic paper, suitable for traditional chemical photographic processes. This patent teaches application of a repositionable adhesive to the back of a standard photographic print with a release layer applied thereover so that, upon peeling the photograph from the release layer, the photograph, with its adhesive can be stuck to another surface, such as a photograph album. In the teachings of Courmoyer et al, as with Imai, the adhesive remains with the photographic layer.

U.S. Pat. No. 3,359,107 issued to Goffe et al has a somewhat different teaching of a laminated photographic element based on traditional chemical developing. However, Goffe et al teach a paper liner with an adhesive coating to which is attached a photographic layer. The photographic layer is removable from the adhesive coating and liner. However, Goffe et al teach the layered photographic element and not the present photographic element, as will be clear from the following.

It would be desirable to completely fill the useful area of the digital photographic paper without leaving the white border framing the photo. The useful area, however, must allow a marginal area as a “safety margin.”

Paper exists in the market that allows for the removal of the border after printing by detaching it. This type of paper uses micro-serrations to facilitate separation of the photograph from its border. Thus, the printed photograph made with prior art digital photograph paper appears similar to a photo made using a traditional flat sheet printing system but the micro-serrations leave an irregular edge on one or more sides, which devalues the final, finished photograph and falls short of the main purpose of this type of photographic printing, i.e., to be equivalent to a traditional photograph made by chemical processes on photographic development paper.

Thus, there remains a need for a better photographic paper for use with digital, ink-jet printers

### SUMMARY OF THE INVENTION

The present invention not only overcomes the shortcomings of the prior art, but also adds undeniable advantages when producing digital photographic paper for ink-jet printers in the desired sizes. The present method eliminates the micro-serrations, although preserving the marginal portions (called safety margins) and the white borders for a good presentation of the photographs. The safety margins are easily removed after printing for disposal, without the need for micro-serrations that add an undesirable roughness to the photographs' edges, in addition to presenting a risk of tearing the photographs if the micro-serrations are not well made. Once peeled from the present digital photographic sheets, they have no white borderm no rough edges and no adhesive on the back. Rather, they have the same appearance as photographs printed using traditional chemical processes on traditional photographic emulsion papers.

Other features and their advantages will become readily apparent to those skilled in the art of digital photographic paper from a careful reading of the Detailed Description of Preferred Embodiments, accompanied by the drawings.

### BRIEF DESCRIPTION OF THE DRAWINGS

In the drawings,

Fig. I is a top view of a digital photographic paper according to a preferred embodiment of the present invention;

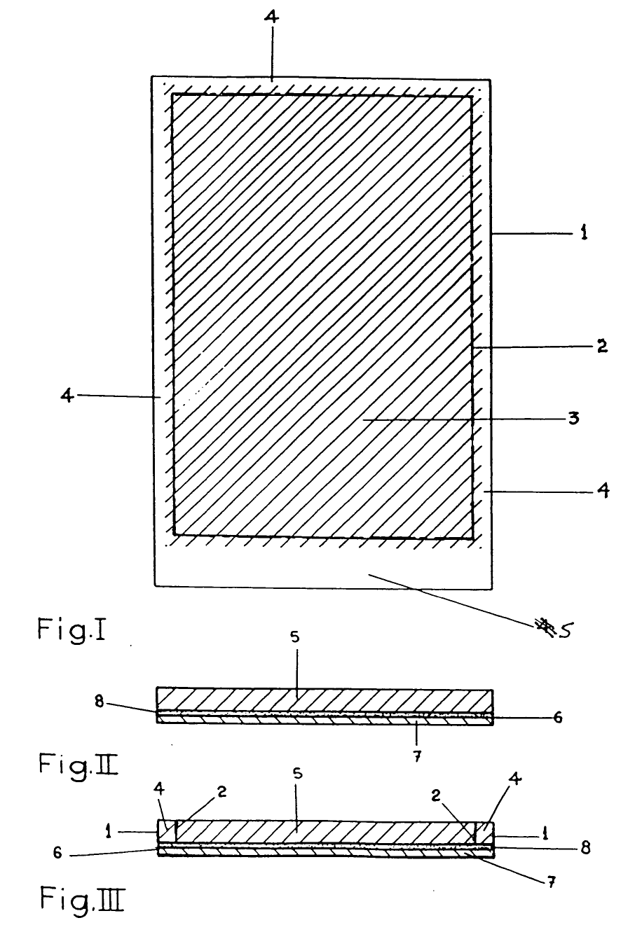

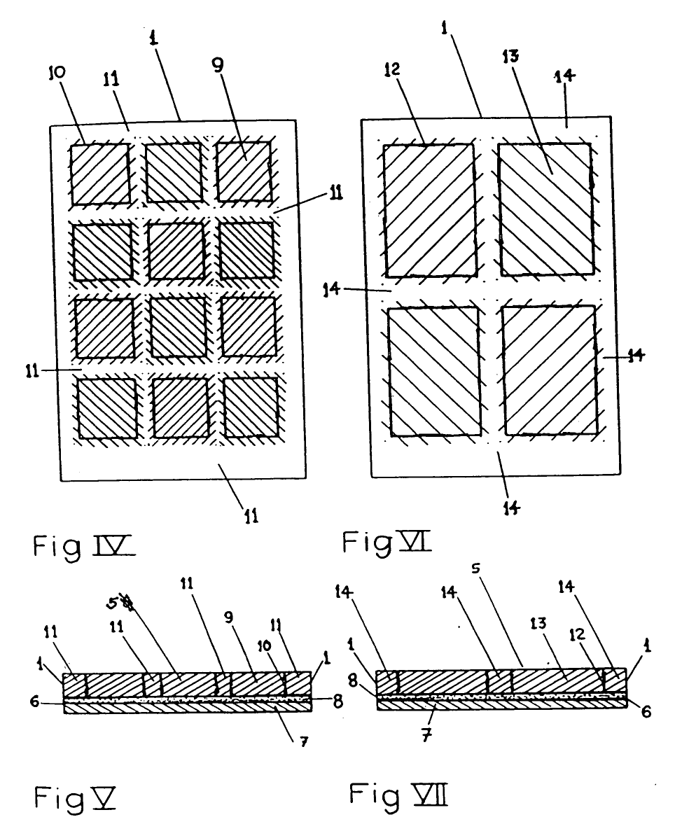

Fig. II is a cross sectional end view of the paper of FIG. 1 prior to the half-cut step;

Fig. III is a cross sectional end view of the paper of FIG. 1 after the half-cut step;

Fig. IV is an alternative digital photographic paper, according to a preferred embodiment of the present invention;

Fig. V is a cross sectional end view of the paper of Fig. IV;

Fig. VI is another alternative digital photographic paper, according to a preferred embodiment of the present invention;

Fig. VII is a cross sectional end view of the digital photographic paper of Fig. VI.

### DETAILED DESCRIPTION OF PREFERRED EMBODIMENTS

The process of the present invention consists in producing a laminated digital photographic paper product, which includes a liner, that is a low weight paper, coated with a low tack adhesive, i.e., of low adhering capacity, and the photographic paper adhered to the liner. The weight of the liner (meaning weight per standard page or per uniform quantity of pages) is low if it is less than the weight of the photographic paper adhered to it so that the liner is more likely to bend than the photographic paper.

Low tack adhesive is well known in that it holds temporarily another layer to it but the other layer is easily peeled from it without adhesive residue remaining on the peeled layer. Such an adhesive is found on POST IT notes manufactured by the Minnesota Mining and Manufacturing Company and other manufacturers. See also U.S. Pat. No. 6,586,510, which describes removable emulsion pressure sensitive adhesives.

The laminated product is coiled for use cutting equipment. This equipment is regulated in accordance with the user's requirements of producing particular pre-selected cuts in the coiled sheet and pre-selected sizes of photographic areas such as, for instance, 3×4 cm, 10×15 cm, etc., preferably using as much of the photographic paper as possible.

The coiled laminated product is introduced into the cutting equipment that proceeds to make a first, half-cut. The half-cut extends through the photographic paper but not through the low weight liner and low tack adhesive. The half-cut defines the photograph area, which is preferably inside the area where the photographic image will be printed so that the image not only covers the photograph area but also extends past the half-cut leaving no white border. Preferably, the half-cut is made so that the photograph area has rounded corners. Then a second, full cut, is made, this cut extending through the whole laminated product (photographic paper, adhesive and liner) and defines a final size of A4, A6 sheet, etc., including safety margins around the photograph area. The result is a series of standard sheets of pre-defined sizes that fit into typical inkjet printers, and that each have standard photographic area sizes, also pre-defined, within the safety margins of the sheets. The photographic images can then be printed using any ink-jet printer, in black and white or full color, and the photographs then peeled from the sheets, leaving the liner with marginal portion and adhesive for disposal. The photographs will have no adhesive stuck to the back of them and no rough, micro-serrated edges.

In the present invention the removal of margins has been made, after printing, very easy by the advantages presented. The first advantage is the half cut, which is a total peripheral uninterrupted cut rather than micro-serrated cut, and it extends partway through the laminated product, namely, through only the photographic paper but not also through the liner and adhesive. As a result, the marginal portion of the photographic paper remains with the liner and adhesive when the photograph portion is peeled from it. The second advantage is the use of a low tack adhesive applied to the liner paper rather than the photograph. This low tack adhesive sticks to the liner but not to the back of the digital photographic paper when the latter is peeled from the liner. These two advantages combine to produce a photograph made with an ink-jet printer that does not have rough micro-serrated edges, avoids the tearing of the photograph that can result from the inefficiency of the micro-serrated cuts, and has no adhesives residue stuck to the back of the photograph. Thus, the photograph has an excellent finished appearance, smooth edges and no undesirable white border.

Drawings presented show the present invention, only by way of example of the preferred embodiment, to emphasize it characteristics and show the great advantages of the invention.

Figure I shows an upper view of a sheet ready for detaching from laminated product where (1) represents the external borders of the sheet, defined by the second cut made by the cutting equipment on the laminated product sheet; (2) represents the half-cut made on photographic paper, without reaching the liner; (3) represents the area designated for the application of the photograph on the photographic paper, it being obvious that the photograph extends beyond the cut (2), assuring that there is no white margin within the area designated for the photograph; (4) is the safety margin to be detached after the image is made on the photograph area.

Figure II shows a front horizontal cross-section of laminated, uncut product where (5) is the photographic paper; (6) is the liner formed by the low weight paper (7) and by the low tack adhesive (8).

Figure III shows a front horizontal cross-section of the laminated cut product, showing the photographic paper (5) half-cut on its two sides at (2) and the liner (6), not being affected by cut (2); (1) is the external edge of the laminate product sheet; (4), the safety margins to be detached; (7), the low weight paper; and (8); the low tack adhesive.

Figure IV shows an upper view of a sheet already detached from laminate, where (1) indicates the borders defined by the second cut of the equipment; (10) is the half-cut only extending through the photographic paper and forming several areas (9) for 3×4 cm photographs; (11) is the safety margin to be detached from the photographs and that has the white portions and a part of the printed portions, which is the result of printing the photograph beyond the photograph area.

Figure V shows a horizontal front cross-section of the sheet containing 3×4 cm photographs where (5) is the photographic paper; (6) is the liner, formed by the low weight paper (7) and of the low tack adhesive (8); (9) are the areas for photographs; (11) the marginal portions to be detached; (10) half cuts that reach only the photographic paper (5) and (1) the cut of detachment of laminate sheet.

Figure VI shows a product sheet already detached as a result of the second cut, where (1) is the edge of the sheet defined by the second cut, (12) are half-cuts that extend only through the photographic paper, limiting areas (13) for 18×15 cm photographs, and (14) are the safety margins to be detached after printing and that include white borders and parts of the photographic image that have been printed beyond the photograph areas (12).

Figure VII shows a horizontal front cross-sectional view of the sheet containing 18×15 cm photographs where (1) is the edge of the product sheet defined by the second cut; (5) is the photographic paper; (6) is the liner formed by low weight paper (7) and by the low tack adhesive (8); (13) indicates the areas for 18×15 cm photographs; (12) half-cuts for detachment of photographs and that do not extend through the liner (6), which is formed by the low weight paper (7) and of the low tack adhesive (8); (14) are the margins to be detached after printing.

It is therefore apparent to those of ordinary skill that the present invention achieves the objection of the present invention and simplifies making photographs by printers similar to those made by traditional development processes by the use of the low tack adhesive on the liner and the half cut through only the photographic paper, and the second cut through the laminated product.

What is claimed is:

1. A digital photographic product for use in an inkjet printer, said product comprising:
a liner;
an adhesive adhered to said liner;
a photographic paper releasibly carried by said adhesive, said photographic paper having a continuous, uninterrupted half-cut extending through said photographic paper but not through said liner, to define a photograph area smaller than a photographic image to be printed on said photographic paper by an inkjet printer, thereby leaving a marginal portion outside of said photograph area, so that, when said photographic image is printed on said photographic paper using said inkjet printer, said photograph area can be peeled from said marginal portion of photographic paper and said adhesive to produce a photograph having smooth edges and no adhesive adhered to said photograph.

2. The digital photographic product as recited in claim 1, wherein said digital product is dimensioned in standard sizes and said photograph area is dimensioned in standard sizes.

3. The digital photographic product as recited in claim 1, wherein said liner has a weight and said photographic paper has a weight, and said weight of said liner is less than said weight of said photographic paper.

4. The digital photographic product as recited in claim 1, wherein said half-cut is has rounded corners

5. A digital photographic product made by a process comprising the steps of:
releasibly adhering photographic paper to a liner to form a photographic product so that said photographic paper can be peeled from said liner without adhesive remaining on said photographic paper;
cutting said photographic product into uniform sheets of pre-determined size;
making a continuous, uninterrupted, half-cut through said photographic paper but not through said liner of each sheet of said photographic paper to define a photograph area that, when a photographic image is made on said photographic paper of said each sheet, said photograph area can be peeled from said sheet to have a photograph with smooth edges and no adhesive adhered to said photograph.

6. The digital photographic product, as recited in claim 5, wherein said process further comprises the step of printing on said photographic paper with an inkjet printer a photographic image larger than said photograph area so that said photographic image extends beyond said half-cut.

7. The digital photographic product, as recited in claim 5, wherein said process wherein photograph area is a standard size of photograph.

8. The digital photographic product, as recited in claim 5, wherein said photograph area has rounded corners.
